(19) United States
(12) Patent Application Publication
(10) Pub. No.: US 2012/0265825 A1
(43) Pub. Date: Oct. 18, 2012

(54) METHODS AND APPARATUSES FOR CONTROLLING PERCEPTIBILITY OF LOCATION-BASED MESSAGES

(75) Inventors: Jesper Sandberg, Valby (DK); Anna Klit Olesen, Frederiksberg (DK)

(73) Assignee: Nokia Corporation

(21) Appl. No.: 13/088,876

(22) Filed: Apr. 18, 2011

(51) Int. Cl. G06F 15/16

(52) U.S. Cl. 709/206

(57) ABSTRACT

Methods and apparatuses are provided for controlling perceptibility of location-based messages. A method may include determining a distance between a location of an apparatus and a location associated with a received message. The method may further include controlling perceptibility of content of the message based at least in part on the determined distance. Corresponding apparatuses are also provided.

### TECHNOLOGICAL FIELD

Example embodiments of the present invention relate generally to communications technology and, more particularly, to methods and apparatuses for controlling perceptibility of location-based messages.

### BACKGROUND

The modern computing era has brought about a tremendous expansion in computing power as well as increased affordability of computing devices. This expansion in computing power has led to a reduction in the size of computing devices and given rise to a new generation of mobile devices that are capable of performing a wide range of functionalities. Consequently, mobile computing devices having a small form factor are becoming increasingly ubiquitous and are used by users of all socioeconomic backgrounds for a wide variety of purposes.

These evolved mobile computing devices allow users to take advantage of networking technologies, which facilitate information transfer and communication between users of computing devices. For example, many users frequently use mobile computing devices to exchange messages with friends, family, coworkers, and other contacts.

### BRIEF SUMMARY

Methods, apparatuses, and computer program products are herein provided for controlling perceptibility of location-based messages. Methods, apparatuses, and computer program products in accordance with various embodiments may provide several advantages to computing devices and computing device users. Some example embodiments provide for controlling perceptibility of content of a received message based at least in part on a distance between a location of an apparatus that received the message and a location associated with the received message. For example, in some example embodiments, the perceptibility of content of the message may be increased as the distance between the location of the receiving apparatus and the location associated with the received message decreases. Accordingly, such example embodiments may provide an interactive user experience whereby user interest in a received message may be enhanced due to curiosity about the content of a received message, which in some example embodiments may not be fully revealed until the user is within a predefined distance of the location associated with the received message.

In a first example embodiment, a method is provided, which comprises determining a distance between a location of an apparatus and a location associated with a received message. The method of this example embodiment further comprises controlling perceptibility of content of the message based at least in part on the determined distance.

In another example embodiment, an apparatus comprising at least one processor and at least one memory storing computer program code is provided. The at least one memory and stored computer program code are configured, with the at least one processor, to cause the apparatus of this example embodiment to at least determine a distance between a location of the apparatus and a location associated with a received message. The at least one memory and stored computer program code are configured, with the at least one processor, to further cause the apparatus of this example embodiment to control perceptibility of content of the message based at least in part on the determined distance.

In a further example embodiment, a computer program product is provided. The computer program product of this example embodiment includes at least one computer-readable storage medium having computer-readable program instructions stored therein. The program instructions of this example embodiment comprise program instructions configured to determine a distance between a location of the apparatus and a location associated with a received message. The program instructions of this example embodiment further comprise program instructions configured to control perceptibility of content of the message based at least in part on the determined distance.

In still another example embodiment, an apparatus is provided that comprises means for determining a distance between a location of the apparatus and a location associated with a received message. The apparatus of this example embodiment further comprises means for controlling perceptibility of content of the message based at least in part on the determined distance.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates an example system according to some example embodiments

FIG. 2 is a schematic block diagram of a mobile terminal according to some example embodiments;

FIG. 3 illustrates a block diagram of an apparatus according to some example embodiments;

FIG. 4 illustrates an example of controlling perceptibility of image content based on location in accordance with some example embodiments;

FIGS. 5a-5c illustrate an example of controlling perceptibility of text content based on location in accordance with some example embodiments;

FIG. 6 illustrates a flowchart according to an example method for controlling perceptibility of message content according to some example embodiments; and

FIG. 7 illustrates a flowchart according to another example method for controlling perceptibility of message content according to some example embodiments.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like.

The term “computer-readable medium” as used herein refers to any medium configured to participate in providing information to a processor, including instructions for execution. Such a medium may take many forms, including, but not limited to a non-transitory computer-readable storage medium (for example, non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Examples of non-transitory computer-readable media include a floppy disk, hard disk, magnetic tape, any other non-transitory magnetic medium, a compact disc read only memory (CD-ROM), compact disc-rewritable (CD-RW), digital versatile disc (DVD), Blu-Ray, any other non-transitory optical medium, a random access memory (RAM), a programmable read only memory (PROM), an erasable programmable read only memory (EPROM), a FLASH-EPROM, any other memory chip or cartridge, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

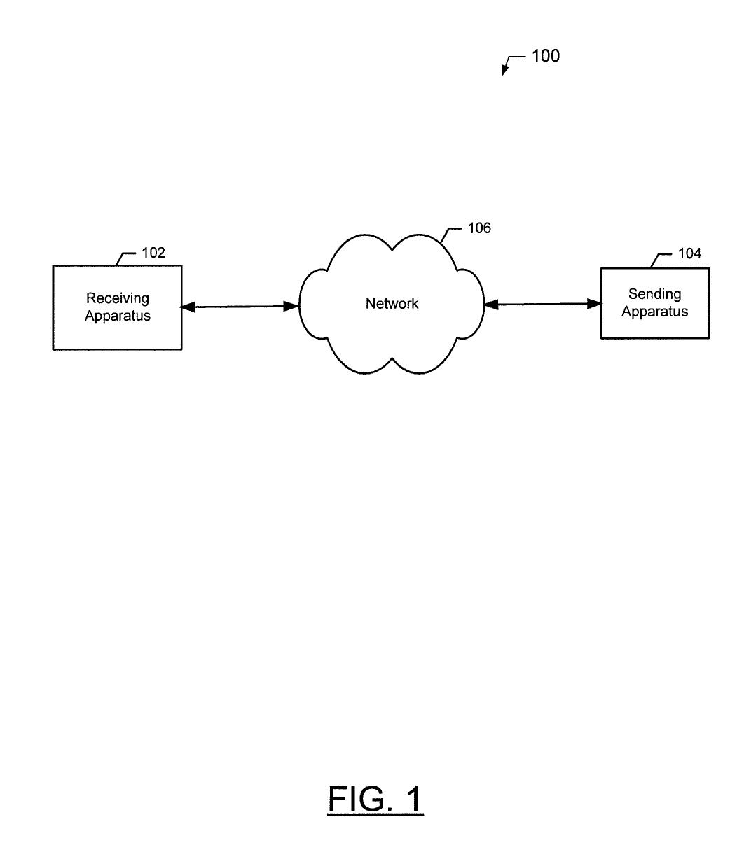

FIG. 1 illustrates an example system 100 that may be used for sending and receiving location-based messages in accordance with some example embodiments. It will be appreciated that the system 100 is provided as an example of some embodiments and should not be construed to narrow the scope or spirit of the invention in any way. In this regard, the scope of the disclosure encompasses many potential embodiments in addition to those illustrated and described herein. As such, while FIG. 1 illustrates one example system in which example embodiments may be implemented, other configurations may also be used to implement various embodiments.

The system 100 may include a plurality of apparatuses that may be in communication via a network 106. In the example illustrated in FIG. 1, a receiving apparatus 102 and a sending apparatus 104 are illustrated. In this regard, a sending apparatus 104 may be configured to send a message to the receiving apparatus 102 via the network 106. It will be appreciated, however, that the apparatuses 102 and 104 are labeled as “receiving apparatus” and “sending apparatus” merely for purposes of illustrative example in order to illustrate communication of a message from a sending apparatus to a receiving apparatus. In this regard, a receiving apparatus 102 may also be capable of sending a message and a sending apparatus 104 may also be capable of receiving a message. As such, it will be appreciated that the terms “receiving apparatus” and “sending apparatus” are used herein to describe a role played in communication of a message from a sender and receiver and do not impart any limitation on the capabilities of the respective apparatuses.

The network 106 may comprise one or more wireless networks (for example, a cellular network, wireless local area network, wireless personal area network, wireless metropolitan area network, and/or the like), one or more wireline networks, a wireless link (e.g., a radio link or other interface between a mobile apparatus and a network access point), or some combination thereof, and in some embodiments may comprise at least a portion of the internet.

The receiving apparatus 102 and sending apparatus 104 may each be embodied as any computing device. By way of non-limiting example, the receiving apparatus 102 and/or sending apparatus 104 may be embodied as a desktop computer, laptop computer, mobile terminal, mobile computer, mobile phone, mobile communication device, one or more servers, one or more network nodes, game device, digital camera/camcorder, audio/video player, television device, radio receiver, digital video recorder, positioning device, chipset, a computing device comprising a chipset, any combination thereof, and/or the like.

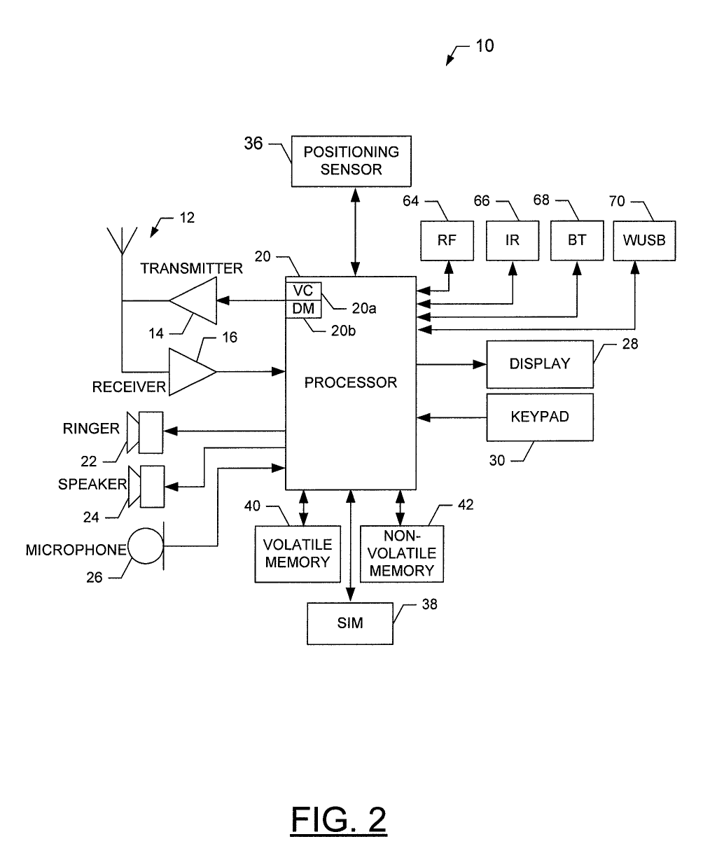

In an example embodiment, the receiving apparatus 102 and/or sending apparatus 104 may be embodied as a mobile computing device, such as a mobile terminal, such as that illustrated in FIG. 2. In this regard, FIG. 2 illustrates a block diagram of a mobile terminal 10 representative of one embodiment of a receiving apparatus 102 and/or sending apparatus 104. It should be understood, however, that the mobile terminal 10 illustrated and hereinafter described is merely illustrative of one type receiving apparatus 102 and/or sending apparatus 104 that may implement and/or benefit from various embodiments of the invention and, therefore, should not be taken to limit the scope of the disclosure. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the interne or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The display 28 of the mobile terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

The mobile terminal 10 may further include a positioning sensor 36. The positioning sensor 36 may include, for example, a global positioning system (GPS) sensor, an assisted global positioning system (Assisted-GPS) sensor, and/or the like. In some example embodiments the positioning sensor 36 may additionally or alternatively include a pedometer or inertial sensor. Further, the positioning sensor 36 may be configured to determine the location of the mobile terminal based at least in part upon signal triangulation and/or other mechanisms. The positioning sensor 36 may be configured to determine a location of the mobile terminal 10, such as latitude and longitude coordinates of the mobile terminal 10 or a position relative to a reference point such as a destination or a start point. Information from the positioning sensor 36 may be communicated to a memory of the mobile terminal 10 or to another memory device to be stored as a position history or location information. Furthermore, the memory of the mobile terminal 10 may store instructions for determining cell identification (id) information. In this regard, the memory may store an application program for execution by the processor 20, which may determine an identity of the current cell, e.g., cell id identity or cell id information, with which the mobile terminal 10 is in communication. In conjunction with the positioning sensor, the cell id information may be used to more accurately determine a location of the mobile terminal 10. Additionally or alternatively, the positioning sensor 36 may be configured to determine a location of the mobile terminal 10 based at least in part on an identification of a network and/or network access point to which the mobile terminal 10. As an example, the positioning sensor 36 may determine the identity of a Wi-Fi network to which the mobile terminal 10 is connected and may use the determined identity as a location reference.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (e.g., Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wi-Fi, WLAN techniques such as IEEE 802.11 techniques, IEEE 802.15 techniques, IEEE 802.16 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. One or more of the volatile memory 40 or non-volatile memory 42 may be embodied as a tangible, non-transitory memory. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

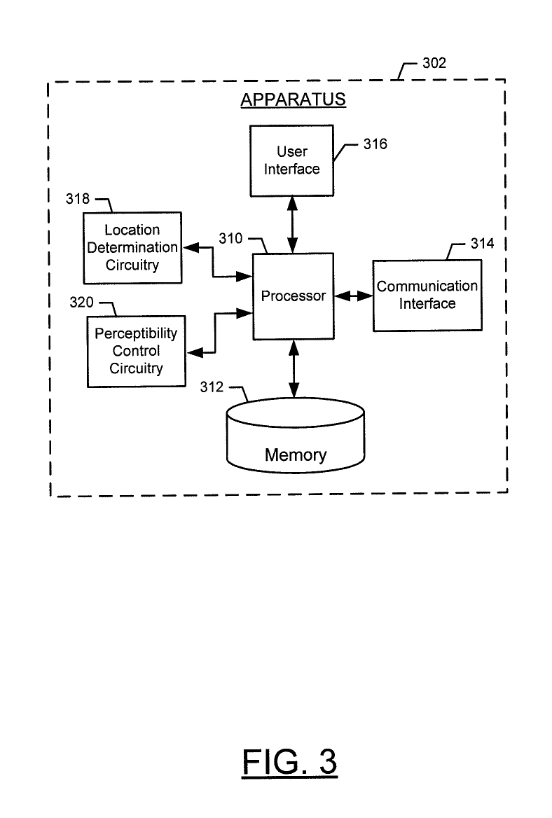

Referring now to FIG. 3, a block diagram of an apparatus 302 according to some example embodiments is illustrated. The apparatus 302 may, for example be implemented on a receiving apparatus 102 and/or on a sending apparatus 104 in some example embodiments. In some example embodiments, the apparatus 302 may include various means for performing the various functions herein described. These means may comprise one or more of a processor 310, memory 312, communication interface 314, user interface 316, location determination circuitry 318, or perceptibility control circuitry 320. The means of the apparatus 302 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 312) that is executable by a suitably configured processing device (e.g., the processor 310), or some combination thereof.

In some example embodiments, one or more of the means illustrated in FIG. 3 may be embodied as a chip or chip set. In other words, the apparatus 302 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In this regard, the processor 310, memory 312, communication interface 314, user interface 316, location determination circuitry 318, and/or perceptibility control circuitry 320 may be embodied as a chip or chip set. The apparatus 302 may therefore, in some cases, be configured to or may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 310 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), one or more other types of hardware processors, or some combination thereof. Accordingly, although illustrated in FIG. 3 as a single processor, in some embodiments the processor 310 comprises a plurality of processors. The plurality of processors may be in operative communication with each other and may be collectively configured to perform one or more functionalities of the apparatus 302 as described herein. The plurality of processors may be embodied on a single computing device or distributed across a plurality of computing devices collectively configured to function as the apparatus 302. In embodiments wherein the apparatus 302 is embodied as a mobile terminal 10, the processor 310 may be embodied as or comprise the processor 20. In some example embodiments, the processor 310 is configured to execute instructions stored in the memory 312 or otherwise accessible to the processor 310. These instructions, when executed by the processor 310, may cause the apparatus 302 to perform one or more of the functionalities of the apparatus 302 as described herein. As such, whether configured by hardware or software methods, or by a combination thereof, the processor 310 may comprise an entity capable of performing operations according to one or more example embodiments while configured accordingly. Thus, for example, when the processor 310 is embodied as an ASIC, FPGA or the like, the processor 310 may comprise specifically configured hardware for conducting one or more operations described herein. Alternatively, as another example, when the processor 310 is embodied as an executor of instructions, such as may be stored in the memory 312, the instructions may specifically configure the processor 310 to perform one or more algorithms and operations described herein.

The memory 312 may comprise, for example, volatile memory, non-volatile memory, or some combination thereof. In this regard, the memory 312 may comprise a non-transitory computer-readable storage medium. Although illustrated in FIG. 3 as a single memory, the memory 312 may comprise a plurality of memories. The plurality of memories may be embodied on a single computing device or may be distributed across a plurality of computing devices collectively configured to function as the apparatus 302. In various example embodiments, the memory 312 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 302 is embodied as a mobile terminal 10, the memory 312 may comprise the volatile memory 40 and/or the non-volatile memory 42. The memory 312 may be configured to store information, data, applications, instructions, or the like for enabling the apparatus 302 to carry out various functions in accordance with various example embodiments. For example, in some example embodiments, the memory 312 is configured to buffer input data for processing by the processor 310. Additionally or alternatively, the memory 312 may be configured to store program instructions for execution by the processor 310. The memory 312 may store information in the form of static and/or dynamic information. The stored information may include, for example, content of a received message. This stored information may be stored and/or used by the location determination circuitry 318 and/or perceptibility control circuitry 320 during the course of performing their respective functionalities.

The communication interface 314 may be embodied as any device or means embodied in circuitry, hardware, a computer program product comprising computer readable program instructions stored on a computer readable medium (e.g., the memory 312) and executed by a processing device (e.g., the processor 310), or a combination thereof that is configured to receive and/or transmit data from/to another computing device. In an example embodiment, the communication interface 314 is at least partially embodied as or otherwise controlled by the processor 310. In this regard, the communication interface 314 may be in communication with the processor 310, such as via a bus. The communication interface 314 may include, for example, an antenna, a transmitter, a receiver, a transceiver and/or supporting hardware or software for enabling communications with one or more remote computing devices. The communication interface 314 may be configured to receive and/or transmit data using any protocol that may be used for communications between computing devices. In this regard, the communication interface 314 may be configured to receive and/or transmit data using any protocol that may be used for transmission of data over a wireless network, wireline network, some combination thereof, or the like (e.g., the network 106) by which the apparatus 302 and one or more computing devices may be in communication. As an example, the communication interface 314 may be configured to receive and/or transmit a message from/to a sending apparatus 104, receiving apparatus 102, and/or the like. The communication interface 314 may additionally be in communication with the memory 312, user interface 316, location determination circuitry 318, and/or perceptibility control circuitry 320, such as via a bus.

The user interface 316 may be in communication with the processor 310 to receive an indication of a user input and/or to provide an audible, visual, mechanical, or other output to a user. As such, the user interface 316 may include, for example, a keyboard, a mouse, a joystick, a display, a touch screen display, a microphone, a speaker, and/or other input/output mechanisms. In embodiments wherein the user interface 316 comprises or is in communication with a display, the display may comprise, for example, a cathode ray tube (CRT) display, a plasma display panel (PDP), a liquid crystal display (LCD), a light-emitting diode (LED), an organic light-emitting diode display (OLED), a projector (e.g., a projector configured to project a display on a projection screen, wall, and/or other object), a holographic display, or the like. In embodiments wherein the user interface 316 comprises a touch screen display, the user interface 316 may additionally be configured to detect and/or receive an indication of a touch gesture or other input to the touch screen display. The user interface 316 may be in communication with the memory 312, communication interface 314, location determination circuitry 318, and/or perceptibility control circuitry 320, such as via a bus.

The location determination circuitry 318 may be embodied as various means, such as circuitry, hardware, a computer program product comprising computer readable program instructions stored on a computer readable medium (e.g., the memory 312) and executed by a processing device (e.g., the processor 310), or some combination thereof and, in some embodiments, is embodied as or otherwise controlled by the processor 310. In embodiments wherein the location determination circuitry 318 is embodied separately from the processor 310, the location determination circuitry 318 may be in communication with the processor 310. The location determination circuitry 318 may further be in communication with one or more of the memory 312, communication interface 314, user interface 316, or perceptibility control circuitry 320, such as via a bus.

The location determination circuitry 318 may be configured to determine a location of the apparatus 302. The determined location may comprise a coordinate location (e.g., latitude and longitude coordinates) of the apparatus 302, a name of a location (e.g., a store name, restaurant name, municipality name, or the like) in which the apparatus 302 is located, an address at which the apparatus 302 is located, a cell ID of a cell providing network service to the apparatus 302, an identification of a network (e.g., a Wi-Fi network) to which the apparatus 302 is connected, some combination thereof, or the like. The location determination circuitry 318 may include, for example, a global positioning system (GPS) sensor, an assisted global positioning system (Assisted-GPS) sensor, accelerometer, pedometer, and/or the like to facilitate determination of a location of the apparatus 302. The location determination circuitry 318 may additionally or alternatively be configured to access network identification information, cell ID information, and/or the like that may be available from the communication interface 314.

The perceptibility control circuitry 320 may be embodied as various means, such as circuitry, hardware, a computer program product comprising computer readable program instructions stored on a computer readable medium (e.g., the memory 312) and executed by a processing device (e.g., the processor 310), or some combination thereof and, in some embodiments, is embodied as or otherwise controlled by the processor 310. In embodiments wherein the perceptibility control circuitry 320 is embodied separately from the processor 310, the perceptibility control circuitry 320 may be in communication with the processor 310. The perceptibility control circuitry 320 may further be in communication with one or more of the memory 312, communication interface 314, or user interface 316, such as via a bus.

In some example embodiments, the perceptibility control circuitry 320 may be configured to receive a message sent to the apparatus 302, such as by a sending apparatus 104. The message may comprise any type of message that may be exchanged between computing devices. By way of non-limiting example, the received message may comprise a text message (e.g., a short message service (SMS) message), a multimedia message (e.g., a multimedia messaging service (MMS) message), an electronic mail (email) message, an instant message (IM), or the like.

The message may comprise a location-based message having an associated location. The location associated with the message may, for example comprise a coordinate location (e.g., latitude and longitude coordinates) of the apparatus 302, a name of a location (e.g., a store name, restaurant name, municipality name, or the like) in which the apparatus 302 is located, an address at which the apparatus 302 is located, a cell ID of a cell providing network service to the apparatus 302, an identification of a network (e.g., a Wi-Fi network) to which the apparatus 302 is connected, some combination thereof, or the like. As an example, the location associated with the received message may comprise a location from which the message was sent (e.g., a location at which the sending apparatus was located when sending the message). As another example, the location associated with the received message may comprise a location that a sender of the message tagged the message with or otherwise associated with the message.

The perceptibility control circuitry 320 may be configured to determine the location associated with the received message. The perceptibility control circuitry 320 may be further configured to determine a location of the apparatus 302 with the assistance of the location determination circuitry 318. The perceptibility control circuitry 320 may determine a distance between the location of the apparatus 302 and the location associated with the received message and may control perceptibility of content of the message based at least in part on the determined distance. In this regard, for example, the perceptibility control circuitry 320 may control an extent to which content of the message is perceptible (e.g., visible, audible, and/or the like) by way of an output of the user interface 316.

In some example embodiments, the perceptibility control circuitry 320 may increase perceptibility (e.g., gradually) of the content of the message as the distance between the location of the apparatus 302 and the location associated with the message decreases. The location of the apparatus 302 may accordingly be monitored (e.g., continuously, at periodic intervals, at aperiodic intervals, or otherwise) and the perceptibility control circuitry 320 may recalculate the distance between the location of the apparatus 302 and the location associated with the message. The perceptibility of the content of the message may accordingly be updated responsive to a change in the distance between the location of the apparatus 302 and the location associated with the message.

The content of the message may be fully revealed in response to a determination that the location of the apparatus 302 is within a predefined distance of the location associated with the message. In this regard, a message received by the apparatus 302 may be “left for” the apparatus 302 at the associated location. For example, the content of the message may be fully revealed in response to a determination that the apparatus 302 is located at the location associated with the message.

In some example embodiments, the location associated with a received message may be indicated to the user. For example, the location associated with the received message may be displayed on a display of the user interface 316. As another example, the associated location may be audibly output to the user via a speaker associated with the user interface 316. Accordingly, the user may be informed of the location to which the user needs to travel toward to reveal the content of the message.

In other example embodiments, a user of the apparatus 302 may not be informed of the location associated with the message. In such embodiments, the user may play a “game” to reveal the content of the message. In this regard, the user may gauge whether he or she is moving in a direction of the location associated with the message by monitoring whether perceptibility of the content of the message is increasing or decreasing.

In some example embodiments, the perceptibility control circuitry 320 may be configured to determine a type (e.g., image, video, text, audio, and/or the like) of content included in a received message. The perceptibility control circuitry 320 may control perceptibility of the content of the message based on the determined type. In this regard, perceptibility may be controlled differently for different types of content.

For example, content of a received message may comprise image content, such as a still image, a video clip, and/or the like. In such an instance, the perceptibility control circuitry 320 may be configured to control perceptibility of the image content by controlling visibility of the image content. For example, if the image content is a still image, the perceptibility control circuitry 320 may gradually cause more of the image to be displayed on a display as the apparatus 302 approaches the location associated with the received message. As another example, if the image content is a video clip, the perceptibility control circuitry 320 may gradually allow a longer portion of the video clip to be viewed until allowing the entirety of the video clip to be viewed when the apparatus 302 is within a predefined distance of the location associated with the message.

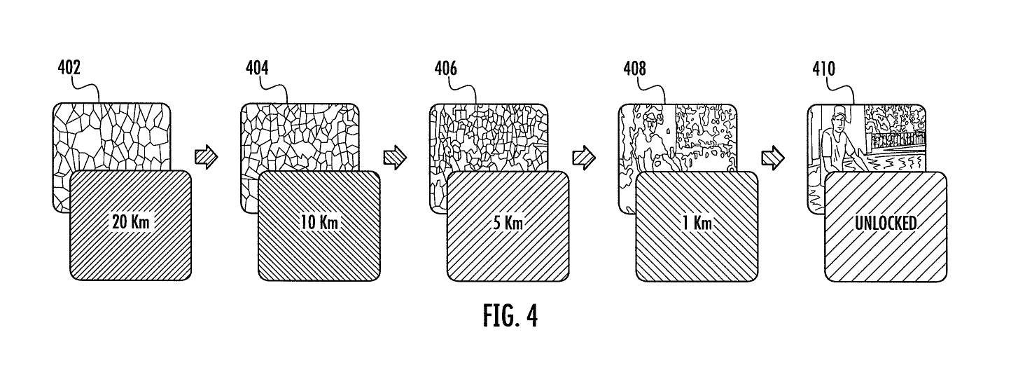

In some example embodiments, the perceptibility control circuitry 320 may control perceptibility of image content by controlling an extent to which the image content (e.g., a still image, video images, and/or the like) is blurred, distorted, or otherwise obscured. For example, the perceptibility control circuitry 320 may use a mosaic filter or other filter to control an extent to which the image content is obscured. As an example, FIG. 4 illustrates an example of controlling perceptibility of image content based on location in accordance with some example embodiments. It will be appreciated that the distances illustrated in and discussed with respect to FIG. 4, as well as the methodology by which the image content of FIG. 4 is obscured are provided by way of example and not by way of limitation. As illustrated, when the apparatus 302 is 20 kilometers (Km) 402 from the location associated with the message, the image content may be significantly obscured. As the apparatus 302 approaches the location associated with the message, the perceptibility control circuitry 320 may reduce the extent to which the image content is obscured. In the example illustrated in FIG. 4, it may be seen that visibility of the image progressively increases as the apparatus 302 comes within 10 Km 404 of the location associated with the message, within 5 Km 406 of the location associated with the message, and within 1 Km 408 of the location associated with the message. When the apparatus 302 arrives at the location associated with the message, the image may be fully revealed, as illustrated by the image 410.

As another example, content of a received message may comprise text content. In such an instance, the perceptibility control circuitry 320 may control perceptibility of the text by controlling legibility of the text, such as may be displayed on a display associated with the user interface 316. For example, the perceptibility control circuitry 320 may control a visibility of displayed text by adjusting an extent to which displayed text is distorted based on a distance between the apparatus 302 and a location associated with the message. As another example, the perceptibility control circuitry 320 may control a number of words and/or letters of the text that are legible (e.g., displayed, displayed in a legible manner, or the like) based on the distance between the apparatus 302 and the location associated with the message. As an example, depending on the distance every n^{th} word or letter of text may be visible, where n is an integer that may vary with the distance between the apparatus 302 and the location associated with the message. As still another example, words of the text may be progressively displayed in order as the apparatus 302 approaches the location associated with the message.

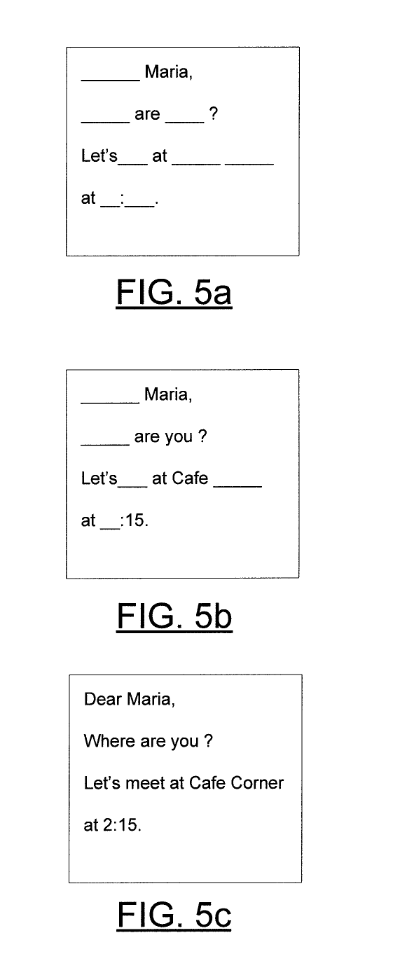

Referring to FIGS. 5a-5c, FIGS. 5a-5c illustrate an example of controlling perceptibility of text content based on location in accordance with some example embodiments. Referring first to FIG. 5a, only a few words of the text content may be legibly displayed when the apparatus 302 is at an initial distance of the location associated with the message. The words that are not legibly displayed may, for example, be represented by blank spaces, as illustrated in FIGS. 5a and 5b. However, it will be appreciated that the user of blank spaces is merely by way of example. As such, alternatives, such as blurring words that are not legibly displayed, not displaying any representation of a word that is not legibly displayed, or the like are within the scope of the disclosure. As the apparatus 302 approaches the location associated with the message, additional words of the text may be displayed, as illustrated in FIG. 5b. When the apparatus 302 arrives within a predefined distance of the location associated with the message, all of the text may be revealed, as illustrated in FIG. 5c.

As another example, content of a received message may comprise audio content. In such an instance, the perceptibility control circuitry 320 may control perceptibility of the audio by controlling an extent to which the audio is distorted, such as when played on a speaker or other audio output of the user interface 316. In this regard, the audio may be progressively less distorted as the apparatus 302 nears the location associated with the message. As another example, the perceptibility control circuitry 320 may gradually allow a longer portion of the audio to be heard until allowing the entirety of the audio clip to be heard when the apparatus 302 is within a predefined distance of the location associated with the message.

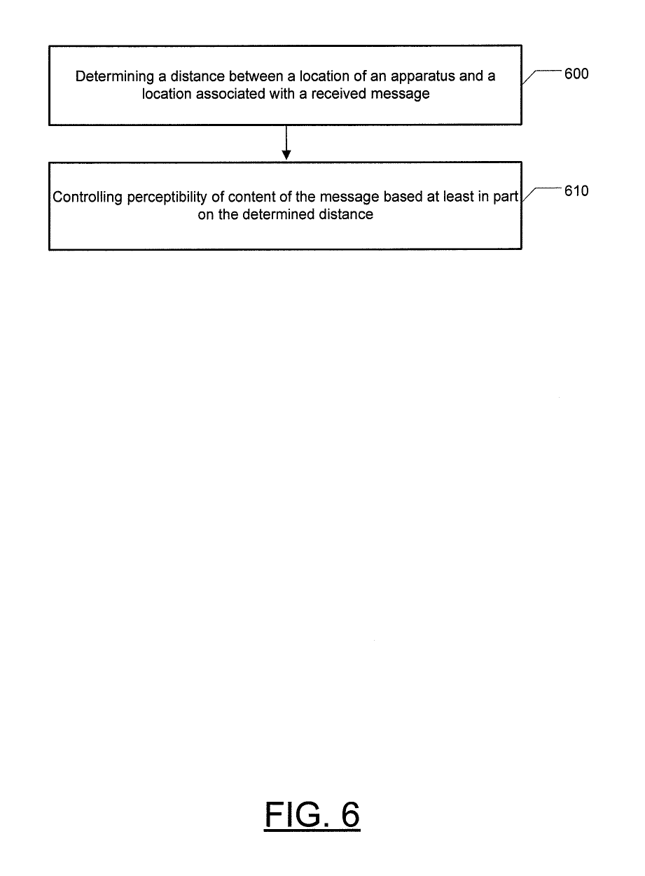

FIG. 6 illustrates a flowchart according to an example method for controlling perceptibility of message content according to some example embodiments. The operations illustrated in and described with respect to FIG. 6 may, for example, be performed by, with the assistance of, and/or under the control of one or more of the processor 310, memory 312, communication interface 314, user interface 316, location determination circuitry 318, or perceptibility control circuitry 320. Operation 600 may comprise determining a distance between a location of an apparatus (e.g., the apparatus 302) and a location associated with a message received by the apparatus. The processor 310, memory 312, location determination circuitry 318, and/or perceptibility control circuitry 320 may, for example, provide means for performing operation 600. Operation 610 may comprise controlling perceptibility of content of the message based at least in part on the determined distance. The processor 310, memory 312, user interface 316, and/or perceptibility control circuitry 320 may, for example, provide means for performing operation 610. The operations 600 and 610 may be performed multiple times, including, for example, continuously, periodically, aperiodically, in response to user request, or the like. For example, the perceptibility of the content may be adjusted responsive to a change in distance between the apparatus and the location associated with the message until the apparatus is within a predefined distance of the location associated with the message, at which point the content may be fully revealed.

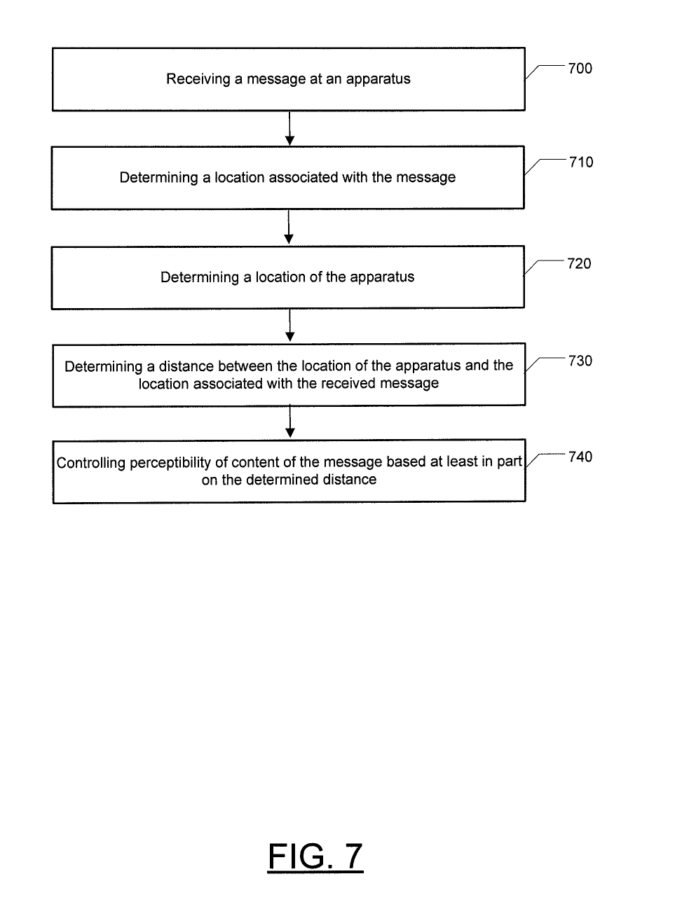

FIG. 7 illustrates a flowchart according to another example method for controlling perceptibility of message content according to some example embodiments. The operations illustrated in and described with respect to FIG. 7 may, for example, be performed by, with the assistance of, and/or under the control of one or more of the processor 310, memory 312, communication interface 314, user interface 316, location determination circuitry 318, or perceptibility control circuitry 320. Operation 700 may comprise receiving a message at an apparatus, such as the apparatus 302. The processor 310, memory 312, communication interface 314, and/or perceptibility control circuitry 320 may, for example, provide means for performing operation 700. Operation 710 may comprise determining a location associated with the message. The processor 310, memory 312, and/or perceptibility control circuitry 320 may, for example, provide means for performing operation 710.

Operation 720 may comprise determining a location of the apparatus 302. The processor 310, memory 312, communication interface 314, location determination circuitry 318, and/or perceptibility control circuitry 320 may, for example, provide means for performing operation 720. Operation 730 may comprise determining a distance between the location of the apparatus and the location associated with the received message. The processor 310, memory 312, and/or perceptibility control circuitry 320 may, for example, provide means for performing operation 730. Operation 740 may comprise controlling perceptibility of content of the message based at least in part on the determined distance. The processor 310, memory 312, user interface 316, and/or perceptibility control circuitry 320 may, for example, provide means for performing operation 740. Operations 720-740 may be performed multiple times, including, for example, continuously, periodically, aperiodically, in response to user request, or the like. For example, the perceptibility of the content may be adjusted responsive to a change in distance between the apparatus and the location associated with the message until the apparatus is within a predefined distance of the location associated with the message, at which point the content may be fully revealed.

FIGS. 6-7 each illustrate a flowchart of a system, method, and computer program product according to an example embodiment. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 312) and executed by a processor in the computing device (for example, by the processor 310). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 302) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, an apparatus 302) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (for example, the processor 310) may provide all or a portion of the elements. In another embodiment, all or a portion of the elements may be configured by and operate under control of a computer program product. The computer program product for performing the methods of an example embodiment of the invention includes a computer-readable storage medium (for example, the memory 312), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
determining a distance between a location of an apparatus and a location associated with a received message; and
controlling, by a processor, perceptibility of content of the message based at least in part on the determined distance.

2. The method of claim 1, wherein controlling perceptibility of the content comprises increasing perceptibility of the content as the distance between the location of the apparatus and the location associated with the received message decreases.

3. The method of claim 1, wherein controlling perceptibility of the content comprises causing the content to be fully revealed in an instance in which it is determined that the location of the apparatus is within a predefined distance of the location associated with the received message.

4. The method of claim 1, wherein the content of the message comprises one or more of image or video content, and wherein controlling perceptibility of the content comprises controlling visibility of the one or more of image or video content.

5. The method of claim 4, wherein controlling visibility of the one or more of image or video content comprises using a mosaic filter to control an extent to which the one or more of image or video content is obscured.

6. The method of claim 1, wherein the content of the message comprises text, and wherein controlling perceptibility of the content comprises controlling legibility of the text.

7. The method of claim 6, wherein controlling legibility of the text comprises controlling a number of words of the text that are legible.

8. The method of claim 1, wherein the content of the message comprises audio content, and wherein controlling perceptibility of the content comprises controlling an extent to which the audio is distorted.

9. An apparatus comprising at least one processor and at least one memory storing computer program code, wherein the at least one memory and stored computer program code are configured, with the at least one processor, to cause the apparatus to at least:
determine a distance between a location of the apparatus and a location associated with a received message; and
control perceptibility of content of the message based at least in part on the determined distance.

10. The apparatus of claim 9, wherein the at least one memory and stored computer program code are configured, with the at least one processor, to cause the apparatus to control perceptibility of the content at least in part by increasing perceptibility of the content as the distance between the location of the apparatus and the location associated with the received message decreases.

11. The apparatus of claim 9, wherein the at least one memory and stored computer program code are configured, with the at least one processor, to cause the apparatus to control perceptibility of the content at least in part by causing the content to be fully revealed in an instance in which it is determined that the location of the apparatus is within a predefined distance of the location associated with the received message.

12. The apparatus of claim 9, wherein the content of the message comprises one or more of image or video content, and wherein the at least one memory and stored computer program code are configured, with the at least one processor, to cause the apparatus to control perceptibility of the content at least in part by controlling visibility of the one or more of image or video content.

13. The apparatus of claim 12, wherein controlling visibility of the one or more of image or video content comprises using a mosaic filter to control an extent to which the one or more of image or video content is obscured.

14. The apparatus of claim 9, wherein the content of the message comprises text, and wherein the at least one memory and stored computer program code are configured, with the at least one processor, to cause the apparatus to control perceptibility of the content at least in part by controlling legibility of the text.

15. The apparatus of claim 14, wherein controlling legibility of the text comprises controlling a number of words of the text that are legible.

16. The apparatus of claim 9, wherein the content of the message comprises audio content, and wherein the at least one memory and stored computer program code are configured, with the at least one processor, to cause the apparatus to control perceptibility of the content at least in part by controlling an extent to which the audio is distorted.

17. The apparatus of claim 9, wherein the apparatus comprises or is embodied on a mobile phone, the mobile phone comprising user interface circuitry and user interface software stored on one or more of the at least one memory; wherein the user interface circuitry and user interface software are configured to:
facilitate user control of at least some functions of the mobile phone through use of a display; and
cause at least a portion of a user interface of the mobile phone to be displayed on the display to facilitate user control of at least some functions of the mobile phone.

18. A computer program product comprising at least one computer-readable storage medium having computer-readable program instructions stored therein, the computer-readable program instructions comprising program instructions configured to cause an apparatus to perform a method comprising:
determining a distance between a location of the apparatus and a location associated with a received message; and
controlling perceptibility of content of the message based at least in part on the determined distance.

19. The computer program product of claim 18, wherein controlling perceptibility of the content comprises increasing perceptibility of the content as the distance between the location of the apparatus and the location associated with the received message decreases.

20. The computer program product of claim 18, wherein controlling perceptibility of the content comprises causing the content to be fully revealed in an instance in which it is determined that the location of the apparatus is within a predefined distance of the location associated with the received message.
